(19) United States
(12) Patent Application Publication
(10) Pub. No.: US 2016/0232763 A1
(43) Pub. Date: Aug. 11, 2016

(54) WIRELESS CAMERA, MICROPHONE, SECURITY, REPEATER, INTERCOM, CONFERENCING AND/OR REMOTE CONTROL SYSTEMS AND METHODS

(71) Applicant: Marc A. Sockol, (US)

(72) Inventor: Marc A. Sockol, Emerald Hills, CA (US)

(21) Appl. No.: 15/009,785

(22) Filed: Jan. 28, 2016

Related U.S. Application Data
(60) Provisional application No. 62/108,844, filed on Jan. 28, 2015.

(51) Int. Cl. G08B 13/196

(52) U.S. Cl. CPC G08B 13/19619; G08B 13/1966; G08B 13/19676; G08B 13/1963; G08B 13/19695; G08B 13/19602

(57) ABSTRACT

A light switch camera system comprises a toggle switch for turning a light on and off, the toggle switch having a central bore; a camera positioned within the central bore for capturing video images; a control unit coupled to the camera for receiving the video images captured by the camera and for controlling at least temporary storage of at least a portion of the video images; and a wireless unit coupled to the control unit for communicating the wireless images to a wireless media capture server.

### CROSS-REFERENCE TO RELATED APPLICATIONS

This application claims priority to U.S. Provisional Patent Application Ser. No. 62/108,844 by Marc A. Sockol, filed on Jan. 28, 2015 and entitled “Wireless Network Camera, Security, Repeater, and Intercom Systems and Methods,” which is hereby incorporated by reference herein.

### TECHNICAL FIELD

Embodiments of the invention relate to home automation, and more particularly provide camera, microphone, security, repeater, intercom, conferencing and/or remote control systems and methods.

### BACKGROUND

Installation of typical security systems on a premises, e.g., home or work, requires a security company to visit the premises and install security cameras and a controller. Installation of the security cameras and controller often requires an electrician to wire power lines to the cameras, which for a quality installation requires opening walls, running wires, and patching/painting the walls. This increases the cost and acts as a financial and practical limit to the number and location of cameras to be installed on the premises.

Further, most security cameras are positioned at the border of the wall and ceiling so that they are relatively inconspicuous. This means that most home security cameras capture video images from a downward angled perspective, which makes it more difficult to capture faces.

### SUMMARY

A light switch system comprises a toggle switch for turning a light on and off, the toggle switch having a central bore; a camera positioned within the central bore for capturing video images; a control unit coupled to the camera for receiving the video images captured by the camera and for controlling at least temporary storage of at least a portion of the video images; and a wireless unit coupled to the control unit for communicating the wireless images to a wireless media capture server.

The camera may be able to pivot. The wireless media capture server may include a persistent store. The wireless media capture server may send the video images to a remote store. The remote store may be accessible by a mobile device. The wireless media capture server may send the video images to a mobile device. The light switch camera system may further comprise an activation control unit configured to activate the camera based on a predetermined condition. The light switch camera system may further comprise a response unit for responding to a predetermined condition. The light switch camera system may include a persistent store. The wireless media capture server may include a security mechanism for controlling access to captured content. The security mechanism may include configurable password protection associated with the light switch camera system. The wireless media capture server may include a response unit for responding to a predetermined condition.

### BRIEF DESCRIPTION OF THE DRAWINGS

FIG. 1 illustrates a light switch system in accordance with some embodiments of the present invention.

FIG. 2 illustrates a door peephole system in accordance with some embodiments of the present invention.

FIG. 3 illustrates a smoke alarm system in accordance with some embodiments of the present invention.

FIG. 4 illustrates a capture and response system in accordance with some embodiments of the present invention.

FIG. 5A illustrates a network system that embodies several capture and response systems in accordance with some embodiments of the present invention.

FIG. 5B illustrates a network system that embodies one or more capture and response systems in accordance with some embodiments of the present invention.

FIG. 6 illustrates a capture and response server in accordance with some embodiments of the present invention.

FIG. 7 illustrates an application in accordance with some embodiments of the present invention.

### DETAILED DESCRIPTION

A data capture and response system may be incorporated into conventional premises devices, such as light switches, smoke alarms, thermostats, and power outlets. Replacing the conventional premises devices with integrated devices comprising capture and response systems adds significant convenience, particularly because the typical premises already has power to the locations of these conventional premises devices. That is, most premises already have power lines wired to the light switches, smoke alarms, thermostats and power outlets. Separate wiring is thus typically unnecessary.

Further, the height, location and direction of many light switches, thermostats and power outlets are often ideal for capturing direct images of faces of individuals on the premises. In addition, each room may offer several alternative locations from which the premises owner or manager can select. For example, a bathroom may have at least one light switch and several outlets at convenient heights, locations and directions. A kitchen may have several light switches and several outlets at convenient heights, locations and directions. Each bedroom has at least one light switch at a convenient height, location and direction.

By replacing one or more conventional premises devices in a room with integrated devices, the premises owner or manager can easily retrofit the premises with an attractive, effective and convenient security system, cameras, microphones, intercoms, remote control systems, conferencing systems, wireless repeaters, etc. These integrated devices may offer additional or alternative benefits such as video and/or audio surveillance, enhanced wireless reach, remote control of computing devices, remote access to computer support functions (such as Siri), remote conferencing and integrated device intercommunication.

It will be appreciated that some integrated devices (such as a door peephole system) may be battery operated and not electrically powered.

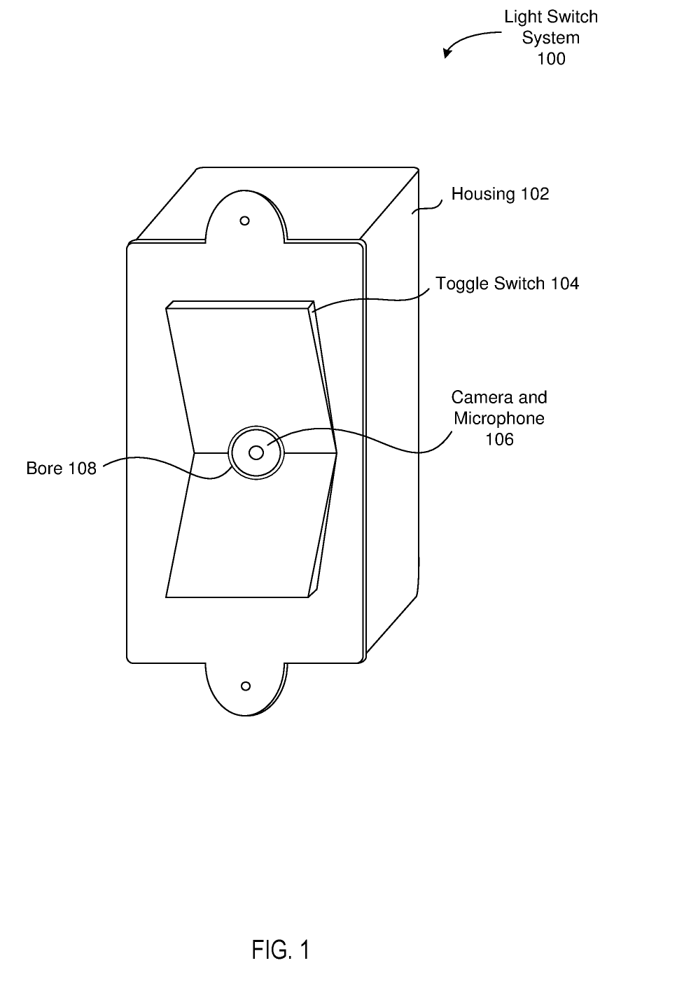

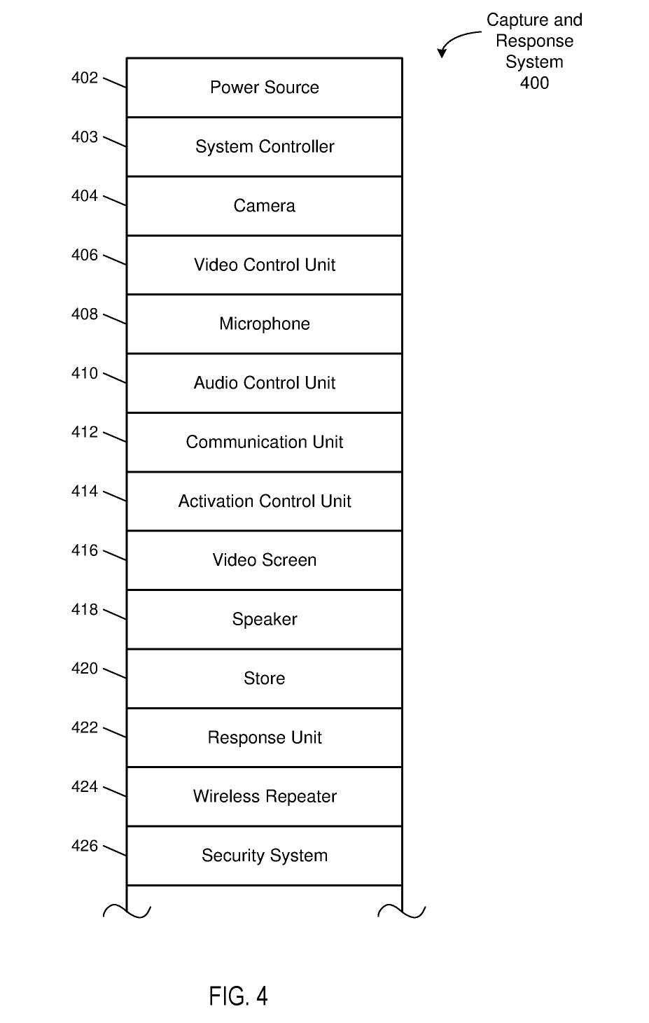

FIG. 1 shows a light switch system 100 comprising a capture and response system (see FIG. 4) integrated into a light switch housing 102, per some embodiments. As shown, the light switch system 100 may include a camera and/or microphone 106 positioned centrally to a decora-style rocker-type toggle switch 104, so that a user's fingers will generally avoid touching the camera and/or microphone 106 when the user is turning the lights on and off. In other embodiments, the light switch system 100 may have the camera and/or microphone 106 positioned in other locations (e.g., above or below a flip-type switch), as a replacement of one of the power plug receptacles of a single power outlet, or on a thermostat. As shown, the light switch system 100 includes a bore 108 for receiving the camera and/or microphone 106, so that the camera and/or microphone 106 is not touched or moved when the user toggles the toggle switch 104. In some embodiments, the light switch system 100 may include a pivot mechanism, e.g., a ball and socket joint, to enable the camera 106 to be manually redirected for better video capture of a room. In some embodiments, the camera 106 may be controlled for pan, tilt and zoom and may be able to move within the bore 108. It will be appreciated that some embodiments may not have a microphone, and some embodiments may not have a camera. FIG. 4 shows details of a capture and response system as disposed inside the light switch housing 102.

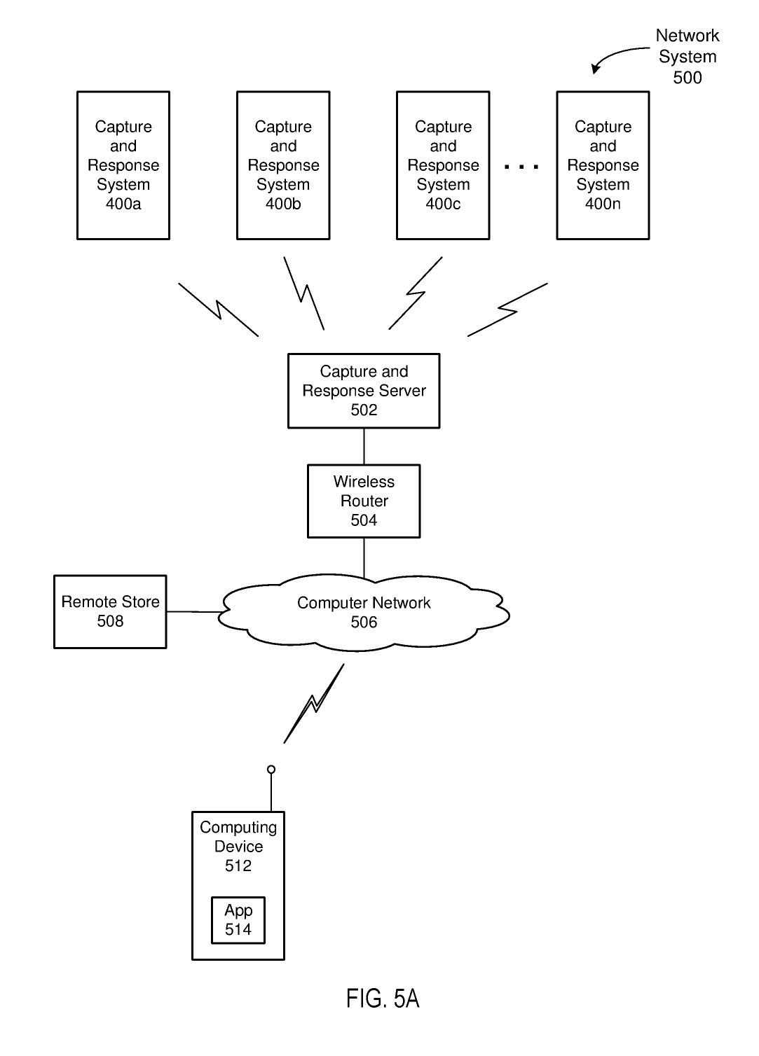

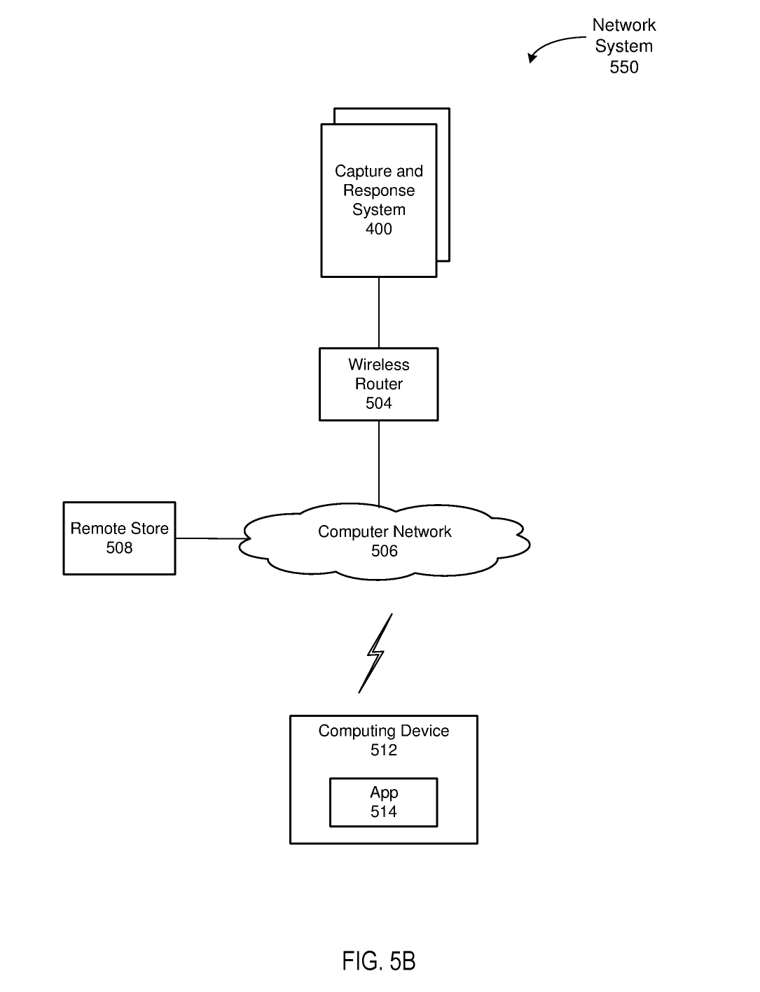

In some embodiments, the light switch system 100 may communicate with a capture and response server (see FIG. 5A) that serves the video and/or audio to a remote store and/or to a computing device, e.g., an iPhone phone or a Samsung Galaxy phone, located anywhere. In some embodiments, the light switch system 100 and a computing device may communicate with the capture and response server to enable various intercommunication functions, such as intercom, video conferencing, video on demand, audio on demand, etc. In some embodiments, the light switch system 100 may communicate (without a capture and response server) through a router with a remote store and/or with a computing device, e.g., an iPhone phone or a Samsung Galaxy phone, located anywhere (see FIG. 5B). In some embodiments, the light switch system 100 and the computing device may communicate directly to enable various intercommunication functions, such as intercom, video conferencing, video on demand, audio on demand, etc.

In some embodiments, the light switch system 100 may be configured to capture video and/or audio when motion and/or sound is detected. In some embodiments, the light switch system 100 may be configured to receive and/or send remote control commands from and/or to other devices, e.g., a computing device, a door peephole system 200, a smoke alarm 300. In some embodiments, the light switch system 100 may be configured to enable an audio and/or video conference function with a computing device and/or other integrated devices. Other embodiments, e.g., as described with reference to FIG. 4, are also possible.

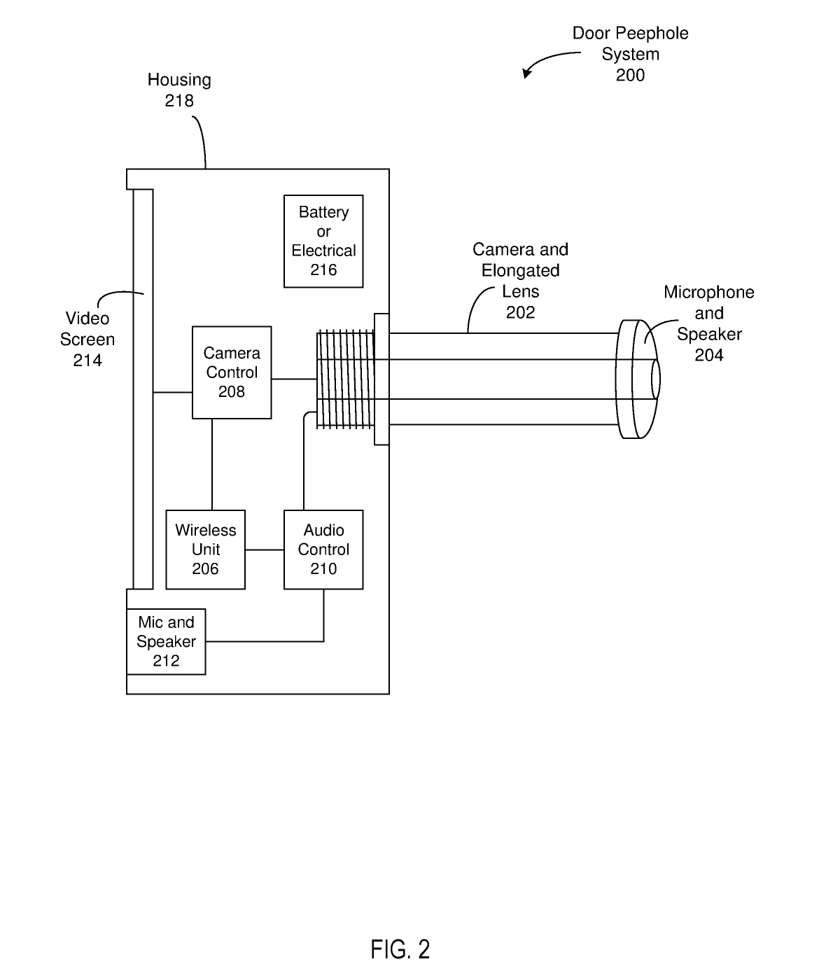

FIG. 2 shows a door peephole system 200 that includes a capture and response system (see FIG. 4) integrated into a system housing 218. As shown, the door peephole system 200 includes a camera with an elongated lens 202 configured to be fed through a door peephole (not shown) in a door. A microphone 204 may also be positioned outside the door peephole. In some embodiments, the door peephole system 200 includes camera control 208 coupled to the camera with the elongated lens 202 and coupled to a display such as an LCD screen 214 and/or to a wireless communication unit 206. In some embodiments, the door peephole system 200 includes audio control 210 coupled to a microphone 204 and a speaker 212 and/or to the wireless unit 206. A power source such as a battery or electrical connection 216 powers the components of the door peephole system 200.

The wireless communication unit 206 may communicate with a capture and response server that serves the video and audio to a remote store and/or to a mobile device, e.g., an iPhone phone or a Samsung Galaxy phone, located anywhere. In some embodiments, the wireless communication unit 206 and a computing device may communicate with the capture and response server to enable various intercommunication functions, such as intercom, video conferencing, video on demand, audio on demand, etc. (see FIG. 5A). In some embodiments, the wireless communication unit 206 may communicate (without the capture and response server) through a router with a remote store and/or to a computing device, e.g., an iPhone phone or a Samsung Galaxy phone, located anywhere (see FIG. 5B). In some embodiments, the wireless communication unit 206 and a computing device may communicate directly to enable various intercommunication functions, such as intercom, video conferencing, video on demand, audio on demand, etc.

The camera control 208 may be configured to capture audio and/or video when motion and/or sound is detected outdoors. The door peephole system 200 may be configured to receive and/or send remote control commands from and/or to other devices, e.g., a smart phone, a light switch system 100, a smoke alarm 300. In some embodiments, the door peephole system 200 may be configured to enable an intercom feature with a mobile phone and/or other integrated devices. In some embodiments, the door peephole system 200 may initiate a call, send a text, or link to a computing device, e.g., when motion and/or sound is detected. Other embodiments, e.g., as described with reference to FIG. 4, are also possible.

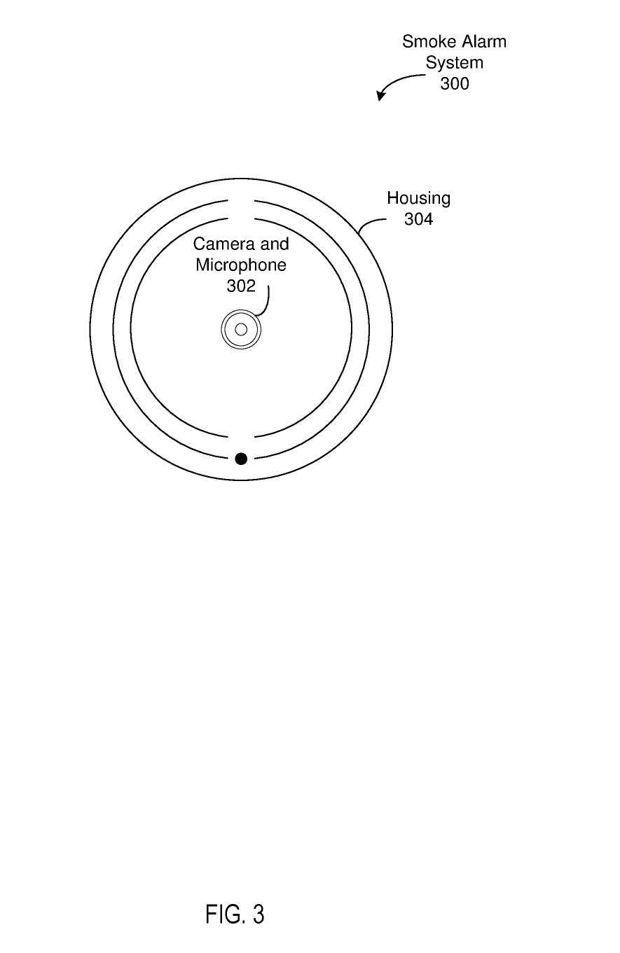

FIG. 3 shows a smoke alarm system 300 that includes a capture and response system (see FIG. 4) integrated into a smoke alarm housing 304. The smoke alarm system 300 may include a camera and/or microphone 302 similar to the camera and/or microphone 106 of the light switch system 100.

The smoke alarm 300 may communicate with a capture and response server that serves the video and/or audio to a remote store and/or to a mobile device, e.g., an iPhone phone or a Samsung Galaxy phone, located anywhere. In some embodiments, the smoke alarm system 300 and a computing device may communicate with the capture and response server to enable various intercommunication functions, such as intercom, video conferencing, video on demand, audio on demand, etc. (see FIG. 5A). In some embodiments, the smoke alarm system 300 may communicate (without the capture and response server) through a router with a remote store and/or with a computing device, e.g., an iPhone phone or a Samsung Galaxy phone, located anywhere (see FIG. 5B). In some embodiments, the smoke alarm system 300 and a computing device may communicate directly to enable various intercommunication functions, such as intercom, video conferencing, video on demand, audio on demand, etc.

The smoke alarm system 300 may be configured to capture audio and/or video when motion and/or sound is detected. The smoke alarm system 300 may be configured to receive and/or send remote control commands from and/or to other devices, e.g., a computing device, a light switch system 100, a door peephole system 200. In some embodiments, the smoke alarm system 300 may be configured to enable an intercom feature with a computing device and/or other integrated devices. In some embodiments, the smoke alarm system 300 may initiate a call, send a text, or link to a mobile phone, e.g., when motion and/or sound is detected, when smoke is detected, or the like. Other embodiments, e.g., as described with reference to FIG. 4, are also possible.

In some embodiments, the light switch system 100, door peephole system 200 and/or smoke alarm system 300 may cooperate with each other. For example, in some embodiments, the door peephole system 200 may instruct the smoke alarm system 300 to sound the an alarm when the door peephole system 200 recognizes an alarm condition, e.g., someone tampering with the door peephole system 200, someone tampering with the lock or doorknob, someone blocking/blinding the camera lens, the sound of breaking glass. In some embodiments, the door peephole system 200 may instruct one or more light switch systems 100 to turn on the lights. Similarly, the light switch system 100 may instruct the smoke alarm system 300 to sound the alarm if a condition is met. Such conditions may include detecting a flashlight, activation of the light switch, blocking/blinding the lens, motion, sound, etc. when a security feature is enabled. Further, the smoke alarm system 300 may instruct the light switch system 100 and/or door peephole system 200 to capture video and/or audio and/or to initiate an emergency verbal broadcast over an integrated speaker when the smoke alarm system 300 detects smoke/carbon monoxide or other emergency condition.

FIG. 4 shows details of a capture and response system 400, in accordance with some embodiments. The capture and response system 400 may be integrated into a premises device such as the light switch system 100, the door peephole system 200, the smoke alarm system 300 and/or other premises devices such as power outlets.

The capture and response system 400 includes a power source 402, such as a battery, electrical, or electrical with battery backup, in some embodiments.

The capture and response system 400 includes a system controller 403. In some embodiments, the system controller 403 is configured to control configuration of the capture and response system 400. In some embodiments, the system controller 403 is configured to control activation and/or deactivation of functions, communication functions (e.g., IP addresses), server operations, etc.

The capture and response system 400 includes a camera 404, a video control unit 406, a video screen 416 and/or a store 420, in some embodiments. The video control unit 406 may control the camera 404 to capture video and control transmission of the captured video to other devices (e.g., to an iPhone phone or a Samsung Galaxy phone). The video control unit 406 may also control presentation on the video screen 416 of video, possibly from the other devices or possibly the captured video (e.g., the video captured through the door peephole system 200). The video control unit 406 may also control the transmission of the captured video to the store 420 for storage, e.g., until the video is transferred to the capture and response server (see FIG. 5A). In some embodiments, the store 420 for storing video can be wired and/or wireless and can be remotely located. In some embodiments, the video screen 416 can be wired and/or wireless and can be remotely located.

The capture and response system 400 further includes a microphone 408, an audio control unit 410 and/or a speaker 418, in some embodiments. The audio control unit 410 may control the microphone 408 to capture audio and control transmission of the captured audio to other devices (e.g., to an iPhone phone or a Samsung Galaxy phone). The audio control unit 408 may also control presentation on the speaker 418 of audio, possibly from the other devices or possibly the captured audio (e.g., the audio captured through the door peephole system 200). The audio control unit 408 may also control the transmission of the captured audio to the store 420 for storage, e.g., until the audio is transferred to the capture and response server (see FIG. 5A). In some embodiments, the store 420 for storing audio can be wired and/or wireless and can be remotely located. In some embodiments, the speaker 418 can be wired and/or wireless and can be remotely located.

The capture and response system 400 includes a communication unit 412. In some embodiments, the communication unit 412 is capable of communicating with the capture and response server for transmitting the video and/or audio data to the server (see FIG. 5A). In some embodiments, the communication unit 412 is capable of communicating the video and/or audio data through a router with a computing device (see FIG. 5B) or store, in some embodiments. The communication unit 412 may be capable of communicating with other devices, e.g., to pass commands and/or to pass video and/or audio data therebetween.

In some embodiments, the communication unit 412 may communicate wirelessly. In some embodiments, the communication unit 412 may communicate via the power lines. In some embodiments, the communication unit 412 of some of the capture and response systems 400 may be configured to communicate using the power lines and the communication unit 412 of some of the capture and responses systems 400 may be configured to communicate wirelessly. In some embodiments, the communication unit 412 of the capture and response systems 400 proximate to a wireless router, a wireless repeater (which may be one of the capture and response systems) and/or another capture and response system 400 may be configured to communicate wirelessly. In some embodiments, the communication unit 412 of the capture and response systems 400 that cannot wirelessly connect with a wireless router, with a wireless repeater and/or with the communication unit 412 of another capture and response system 400 may communicate through the power lines, e.g., with the communication unit 412 of a capture and response system 400 capable of communicating with the wireless router or the capture and response server (see FIG. 5A). Other communication combinations are also possible.

The capture and response system 400 may include a wireless repeater 424 in some embodiments, e.g., to support WiFi on the premises, to support passing of video and/or audio being sent to a computing device, to support passing of commands to other devices such as a mobile phone or another integrated device. The wireless repeater 424 may be part of or integrated with the communication unit 412.

In order to save battery life and reduce data transfer demands, the capture and response system 400 may include an activation control unit 414. The activation control unit 414 may activate the camera 404 and/or the microphone 408 based on a variety of trigger conditions and possibly based on the type of device within which it is integrated. In some embodiments, the activation control unit 414 includes a sensor for sensing a change in an ambient condition and/or an event. For example, the activation control unit 414 in a light switch system 100 may activate the camera 404 and/or microphone 408 when motion and/or sound is detected, when the light is turned on, when a flashlight is detected, upon user request and/or upon an instruction from another integrated device. The activation control unit 414 in a door peephole system 200 may activate the camera 404 and/or microphone 408 when motion and/or sound is detected, when the door bell rings, upon user request and/or upon an instruction from another integrated device. The activation control unit 414 in the smoke alarm system 300 may activate the camera 404 and/or microphone 408 when motion and/or sound is detected, when smoke or carbon monoxide is detected, upon user request and/or upon an instruction from another integrated device. In some embodiments, the activation control unit 414 may enable directionality of motion capture, e.g., to capture only motion occurring above four feet (or other height) to avoid capturing motion of pets. Similarly, the activation control unit 414 may be capable of determining the difference between pet motion and human motion.

The capture and response system 400 may also include a response unit 422 that responds to what it detects, e.g., by passing video and/or audio data therebetween, turning on lights, sounding alarms (e.g., the smoke alarm of the smoke alarm system 300), calling the police or fire department, sending an alert to the home owner, ringing the user's mobile phone, unlocking the door, activating another integrated device, in some embodiments. Some responses may be done by the capture and response server (see FIG. 5A), in response to an instruction by the capture and response system 400, upon evaluation of the video and/or audio data and/or the source of the communication, or the like.

In some embodiments, the activation control unit 414 may receive a voice command. For example, the voice command may be a verbal instruction to a computer support feature, e.g., to Siri or Cortana. The voice command may be a verbal instruction to control another wireless device, such as a wireless thermostat. The response unit 422 may instruct the communication unit 412 to forward the instruction to Apple Computer or Microsoft servers directly or via a mobile phone (whether on or off the premises). The activation control unit 414 may await a response from the communication unit 412, which provides the response function (e.g., presentation of a video and/or audio response, activation of music download, initiating a telephone call, initiating an application on the mobile phone, confirmation of the completion of the command).

In some embodiments, the voice command may be a verbal instruction to a computing device, e.g., a mobile phone, to make a phone call and enable the phone call through the capture and response system 400.

In some embodiments, the system controller 403 may be capable of receiving configuration commands from bar codes, QR codes, or other graphical and/or audio input. For example, an application running on a computing device (e.g., a computing device and/or the capture and response server of FIG. 5A) may request premises information, capture and response system information, user preferences, functions desired, username/passwords, WiFi passwords, and/or the like. The application may generate audio and/or video code that can be inputted at each of the capture and response systems 400. For example, the application may generate a QR code for each capture and response system 400. The QR code can be displayed on a wireless phone. The user can hold the wireless phone in front of the camera 404 of each capture and response system 400, which will enable the wireless phone to capture the QR code, convert it to configuration information and configure itself. In some embodiments, the system controller 403 may be configured through a configuration user interface accessible via a login address or WiFi site.

In some embodiments, the store 420 may store video and/or audio corresponding to a particular capture and response system 400 that is encrypted and/or password protected. Each capture and response system 400 may be encrypted and/or password protected with a different password, so that only the persons with a right to view the captured video and/or audio can access the captured video and/or audio, and share the captured video and/or audio when necessary (e.g., an emergency situation).

In some embodiments, the security system 426 turns all of the capture and response systems 400 on the premises on to monitor for alarm triggers. A user can go to any of the integrated devices on the premises and enter an instruction into the security system 426 to activate or deactivate the monitoring. The instruction may be voice operated or operated from the application on a computing device. The instructions may be biometric, such as facial recognition of any of the faces of persons residing at the premises. The instructions may include holding up a dynamic key that is shown on the user's phone, e.g., a temporary key (e.g., a graphic, QR code, bar code, number) that has only temporary ability to control the deactivation of the security system 426. The key generator may be on a mobile phone. In some embodiments, the instruction may be passed to the security system 426 via an RFID tag, NFC communication, etc., and therefore, only entry of an authorized person could deactivate the security system 426.

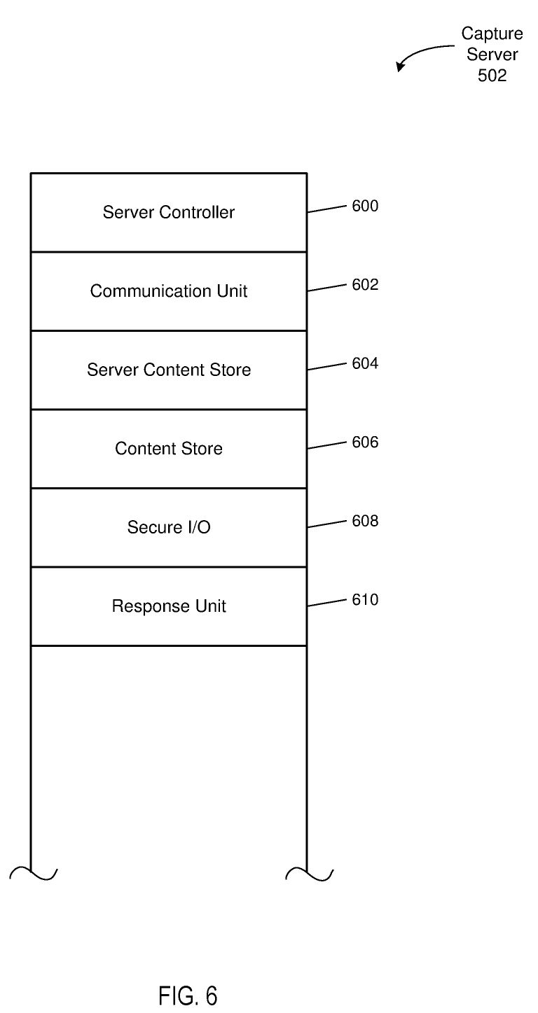

FIG. 5A shows details of a network system 500 that embodies several capture and response systems 400. As shown, the network system 500 includes N capture and response systems 400 (shown as capture and response system 400a, capture and response system 400b, capture and response system 400c . . . capture and response system 400n) in wireless communication with a capture and response server 502. The capture and response server 502 is coupled to a computer network 506 such as the Internet, and possibly includes or is coupled to a standard wireless router 504. The capture and response server 502 may be configured to communicate and/or stream information securely to a remote store 508 and/or a computing device 512 (e.g., a wireless smartphone, a smart television, a desktop, a laptop, a tablet). The computing device 512 may include an application (e.g., an app) 514 that cooperates with the capture and response systems 400. Details of the capture and response server 502 are shown in FIG. 6.

FIG. 5B shows details of a network system 550 that embodies one or more capture and response systems 400 that cooperate with a computing device 512 (with an application 514), without a capture and response server 502. As shown, the network system 550 includes one or more capture and response systems 400 coupled via a wireless router 504, which in turn is coupled to a computer network 506 such as the Internet. The capture and response system 400 may be configured to communicate and/or stream information securely to a remote store 508 and/or computing device 512. The application (e.g., an app) 514 may be configured to cooperate with the capture and response systems 400.

FIG. 6 shows details of the capture and response server 502 in some embodiments. As shown, the capture and response server 502 includes server controller 600 capable of activating and deactivating the functions thereon. The server controller 600 may be capable of obtaining configuration details from a user and of generating configuration codes to configure the capture and response systems 400, as discussed above. The capture and response server 502 includes a communication unit 602 configured to communicate with the capture and response systems 400 and/or with the application 514 on the computing device 512. The communication unit 602 may also provide WiFi services in cooperation with wireless repeaters 424 that may be integrated in the capture and response systems 400. The communication unit 602 may be capable of communicating with the capture and response systems 400 using the power lines to which the capture and response systems 400 may be connected. The capture and response server 502 may include a content (e.g., video and/or audio) store 604, and a content server 606 for transmitting (e.g., streaming) content to the remote store 508 and/or the computing device 512.

The content and response server 502 may include secure input/output (I/O) 608 to support ensuring that private information remains private. In one embodiment, each capture and response system 400 may include a different password protected file of captured content so that the captured content can be maintained as private and only disclosed by the persons who have the passwords. For example, the parents' room may be secured by a password known only to the parents, a kid's bedroom may be secured by a password known only to the kid, etc. In some embodiments, two sets of passwords may be required so that the content may only be reviewed if two separate entities (e.g., the parents and the room occupant) enter the passwords.

The capture and response server 502 may also include a response unit 610 that may call police, call the fire department, send an email or an alert to the computing device 512, call the computing device 512, lock or unlock a door, activate an alarm, relay a command to a target device, transmit content from one component to another, etc. The response unit 610 may respond based on an instruction from a capture and response system 400, upon a trigger condition, upon evaluation of content and/or the source of the content, and/or upon other conditions. In some embodiments, the response unit 610 may be capable of instructing one or more of the capture and response systems 400 to activate and/or deactivate functions.

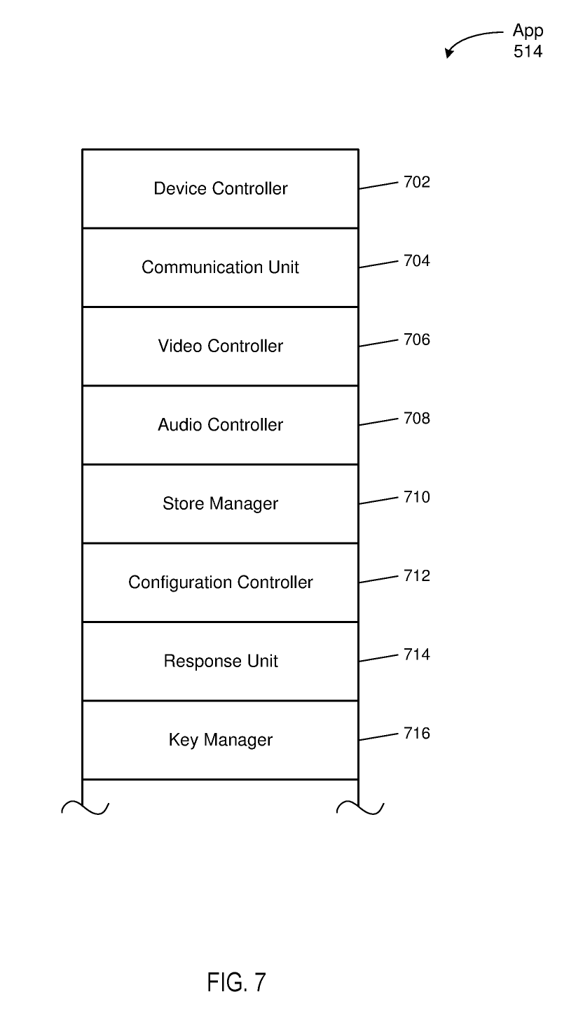

FIG. 7 shows details of an application 514 in some embodiments. The application includes a device controller 702, a communication unit 704, a video controller 706, an audio controller 708, a store manager 710, a configuration controller 712, a response unit 714, and a key manager 716.

The device controller 702 operates to activate and/or deactivate functions of the capture and response systems 400 and/or functions of the capture and response server 502.

The communication unit 704 is capable of communicating over a wired or wireless connection to the capture and response systems 400, to the capture and response server 502 and/or to the remote store 508.

The video controller 706 may be capable of receiving video content and playing back the video content received.

The audio controller 706 may be capable of receiving audio content and playing back the audio content received. In some embodiments, the audio controller 706 is further capable of transmitting audio content back to the capture and response systems 400 and/or to the capture and response server 502. The audio content transmitted may be used to control the capture and response systems 400 and/or the capture and response server 502, and/or for presentation by one or more of the capture and response systems 400.

The store manager 710 may be capable of configuring the remote store 508, the store 420, and/or the server content store 604. The store manager 710 may be capable of retrieving content from the remote store 508, the store 420, and/or the server content store 604. The store manager 710 may be capable of managing passwords for the content associated with each of the capture and response systems 400.

The configuration controller 712 may operate to assist in configuring the capture and response systems 400 and/or the capture and response server 502. In some embodiments, the configuration controller 712 is capable of generating configuration commands in the form of bar codes, QR codes, or other graphical and/or audio input. For example, the configuration controller 712 may request premises information, capture and response system information, user preferences, functions desired, username/passwords, WiFi passwords, and/or the like. The configuration controller 712 may generate audio and/or video code that can be inputted at each of the capture and response systems 400. For example, the configuration controller 712 may generate a QR code for each capture and response system 400. The QR code can be displayed on a wireless phone. The user can hold the wireless phone in front of the camera 404 of each capture and response system 400, which will enable the wireless phone to capture the QR code, convert it to configuration information and configure itself.

The response unit 714 may operate to analyze content for trigger conditioning meriting an automated response, e.g., a call to the police, a call to the fire department, a sounding of one or more premises alarms, an initiating of recording of content by one or more of the capture and response systems 400. The response unit 714 may provide the user with a convenient user interface to enable the user to activate an appropriate response, e.g., a call to the police, a call to the fire department, a sounding of one or more premises alarms, an initiating of recording of content by one or more of the capture and response systems 400.

The key manager 716 may operate to generate temporary keys, to configure RFID or NFC devices to support activation/deactivation of the security system 426, etc.

1. A light switch camera system, comprising:
a toggle switch for turning a light on and off, the toggle switch having a central bore;
a camera positioned within the central bore for capturing video images;
a control unit coupled to the camera for receiving the video images captured by the camera and for controlling at least temporary storage of at least a portion of the video images; and
a wireless unit coupled to the control unit for communicating the wireless images to a wireless media capture server.

2. The light switch camera system of claim 1, wherein the camera is able to pivot.

3. The light switch camera system of claim 1, wherein the wireless media capture server includes a persistent store.

4. The light switch camera system of claim 1, wherein the wireless media capture server sends the video images to a remote store.

5. The light switch camera system of claim 4, wherein the remote store is accessible by a mobile device.

6. The light switch camera system of claim 1, wherein the wireless media capture server sends the video images to a mobile device.

7. The light switch camera system of claim 1, further comprising an activation control unit configured to activate the camera based on a predetermined condition.

8. The light switch camera system of claim 1, further comprising a response unit for responding to a predetermined condition.

9. The light switch camera system of claim 1, further comprising a persistent store.

10. The light switch camera system of claim 1, wherein the wireless media capture server includes a security mechanism for controlling access to captured content.

11. The light switch camera system of claim 10, wherein the security mechanism includes configurable password protection associated with the light switch camera system.

12. The light switch camera system of claim 1, wherein the wireless media capture server includes a response unit for responding to a predetermined condition.
